(19) United States
(12) Patent Application Publication
(10) Pub. No.: US 2004/0176506 A1
(43) Pub. Date: Sep. 9, 2004

(54) Fusible zinc phosphinates

(75) Inventors: Martin Sicken, Koeln (DE); Elke Schlosser, Augsburg (DE); Wolfgang Wanzke, Augsburg (DE); Detlef Burghardt, Osterspai (DE)

Correspondence Address: Clariant Corporation, Industrial Property Department, 4000 Monroe Road, Charlotte, NC, 28205, US

(73) Assignee: Clariant GmbH

(21) Appl. No.: 10/793,396

(22) Filed: Mar. 4, 2004

(30) Foreign Application Priority Data
Mar. 4, 2003 (DE) 103 09 622.1

(51) Int. Cl. C08K 5/49; C08K 3/32; C09K 21/00

(52) U.S. Cl. 524/115; 524/414; 252/609

(57) ABSTRACT

The invention relates to novel fusible zinc phosphinates of the formula (I) and/or polymers thereof

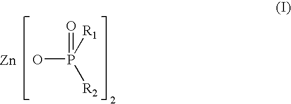

where R¹ and R² are identical or different, and are hydrogen, C₁-C₆-alkyl, linear or branched, and/or aryl, which have a melting point below 250° C.

The invention further relates to a process for preparing these zinc phosphinates, and also to their use as flame retardants in thermoplastics and in moldings, films, filaments, fibers, woven materials, or knitted materials produced therefrom.

The present invention relates to fusible organophosphorus flame retardants based on zinc phosphinates, to their preparation, and to their use.

The combustibility of thermoplastics and thermosets, such as polyamides, polyesters, unsaturated polyester resins, epoxy resins, and polyurethanes, necessitates the use of flame retardants for some applications. Because requirements of the market for fire protection and for environmental compatibility of products are increasing there is a particular increase in the level of interest in halogen-free flame retardants, e.g. solid organophosphorus products.

The salts of phosphinic acids (phosphinates) have proven to be effective flame retardants for thermoplastic and thermoset polymers, and this applies not only to the alkali metal salts (DE 2 252 258 A1) but also to the salts of other metals (DE 2 447 727 A1).

Calcium phosphinates and aluminum phosphinates have been described (EP 0 699 708 A1) as particularly effective in polyesters. Furthermore, phosphinic acids and salts thereof can be prepared by various methods and have been widely described.

The use of these phosphinates in the abovementioned application sectors is limited because they comprise solids which do not melt under the usual conditions of processing. The result of this is that homogeneous incorporation becomes difficult, and that applications in thin-walled items, such as films, foils, and fibers, or moldings which have some thin-walled portions become impossible or are subject to severe limitation. By way of example, there can be blockage of the processing machinery (e.g. dies, extrusion slots, filters, pipelines, pumps), or the properties of the solid (insufficiently free-flowing, not fusible) prevent complete filling of molds on the process machinery.

A further disadvantage of the non-fusible phosphinates is that they cannot be used in transparent final products.

An object was therefore to provide flame retardants which are halogen-free, which have high flame-retardant efficiency, which can be homogenized effectively, and which can even be used in thin-walled items, such as films, foils, and fibers, or in moldings having some thin-walled portions, and which are also acceptable in transparent applications.

The invention achieves the object by using certain zinc phosphinates. Surprisingly, it has been found that, unlike the phosphinates preferentially used hitherto, certain zinc phosphinates melt below the processing temperatures of thermoplastics. They therefore become more uniformly distributed within the polymer, and thus retain the transparency of the materials, if these were previously transparent. They may moreover also be used in thin-walled items, such as films, foils, filaments, and fibers, or in moldings which have some thin-walled portions.

Furthermore, it has surprisingly been found that there is also an improvement in the flame-retardant effect of these zinc phosphinates in applications of this type when comparison is made with the phosphinates of calcium and of aluminum preferentially used in EP-A-0 699 708. Other results of the better homogenization of the inventive fusible phosphinates are better and more pleasing surface finish and surface quality. In addition, this method can also give better mechanical properties of the polymeric material.

The invention therefore provides zinc phosphinates of the formula (I) and/or polymers thereof

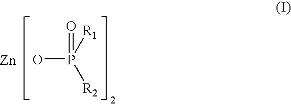

where R¹ and R² are identical or different, and are hydrogen, C₁-C₆-alkyl, linear or branched, and/or aryl, which have a melting point below 250° C. The minimum value for the melting point is about 40° C. or slightly higher.

R¹ and R², identical or different, are preferably C₁-C₆-alkyl, linear or branched, and/or phenyl.

R¹ and R², identical or different, are particularly preferably methyl, ethyl, n-propyl, isopropyl, n-butyl, tert-butyl, n-pentyl and/or phenyl.

The zinc phosphinate particularly preferably comprises zinc dimethylphosphinate, zinc methylethylphosphinate, and zinc diethylphosphinate.

The invention also provides the preparation of the inventive zinc phosphinates.

The preparation uses a reaction of phosphinic acids and/or salts thereof with zinc compounds.

The zinc compounds used preferably comprise zinc chloride, zinc sulfate, zinc acetate, zinc nitrate, zinc oxide, zinc hydroxide, zinc carbonate, zinc hydroxide acetates, and zinc hydroxide carbonates.

The zinc compounds used particularly preferably comprise zinc oxide and zinc sulfate.

Phosphinic acids used preferably comprise dimethylphosphinic acid, methylethylphosphinic acid, and diethylphosphinic acid.

Phosphinic salts used preferably comprise sodium dimethylphosphinate, sodium methylethylphosphinate, and sodium diethylphosphinate.

The inventive zinc phosphinates are preferably prepared in water or acetic acid. Glacial acetic acid is particularly suitable.

In one particular embodiment of the process, the phosphinic acid is reacted with zinc oxide in acetic acid, and the material is then crystallized by vacuum-drying.

In another particular embodiment of the process, the sodium phosphinate is reacted with zinc sulfate in water, and the material is then isolated by filtration, washing, and vacuum-drying.

The invention also provides a flame-retardant thermoplastic molding composition prepared by using the inventive zinc phosphinates.

The thermoplastic preferably comprises polymers of the type represented by HI (high-impact) polystyrene, polyphenylene ethers, polyamides, polyesters, polycarbonates, and blends or polyblends of the type represented by ABS (acrylonitrile-butadiene-styrene) or PC/ABS (polycarbonate/acrylonitrile-butadiene-styrene), or PPE/HIPS (polyphenylene ether/HI polystyrene) plastics.

The thermoplastic particularly preferably comprises polyamides, polyesters, and PPE/HIPS blends.

The thermoplastic molding compositions preferably comprise an amount of from 1 to 50% by weight of the zinc phosphinate.

The thermoplastic molding compositions particularly preferably comprise an amount of from 1 to 25% by weight of the zinc phosphinate.

The plastics preferably comprise other additives, such as synergists, antioxidants, light stabilizers, lubricants, colorants, nucleating agents, fillers, or antistatic agents. EP 0 584 567 A1 gives examples of the additives which may be used.

By way of example, the phosphinates may be incorporated into thermoplastic polymers by premixing all of the constituents in the form of powder and/or pellets in a mixer, and then homogenizing the materials in the polymer melt in a compounding assembly (e.g. a twin-screw extruder). The melt is usually discharged in the form of a strand, cooled, and pelletized. The components may also be introduced separately by way of a feed system directly into the compounding assembly.

It is also possible for the flame-retardant additives to be admixed with a ready-to-use polymer in pellet or powder form, and for the mixture to be processed directly on an injection-molding machine to give moldings.

The invention also provides flame-retardant polymer moldings, flame-retardant polymer films, flame-retardant polymer filaments, and flame-retardant polymer fibers, flame-retardant woven polymer materials, and flame-retardant knitted polymer materials, which comprise, based on the polymer content, an amount of from 1 to 50% by weight of the zinc phosphinate.

The polymer moldings, polymer films, polymer filaments, and polymer fibers, woven polymer materials, and knitted polymer materials preferably comprise polymers of the type represented by HI (high-impact) polystyrene, polyphenylene ethers, polyamides, polyesters, polycarbonates, and blends or polyblends of the type represented by ABS (acrylonitrile-butadiene-styrene) or PC/ABS (polycarbonate/acrylonitrile-butadiene-styrene), polyamide, polyester, and/or ABS.

One method which has proven to be successful universally for determining the flame retardancy of materials is determination of what is known as the oxygen index. This test system uses a vertically arranged test specimen to determine the limiting oxygen concentration required for vertical burning to proceed. The oxygen index was determined in a modified apparatus using a method based on ASTM D 2863-74.

### EXAMPLES

### Example 1

### Inventive

4 l of water formed an initial charge in a 25 l stirred reactor. The system was heated to about 70° C., and a solution of 2.2 kg of ZnSO₄ 7H₂O (7.65 mol) in 2.8 kg of water and 10 kg of a 22% strength solution of sodium diethylphosphinate (15.3 mol) were then metered in simultaneously over a period of 2 h. After a continued reaction time of 30 min, the resultant wet solid was filtered, washed with 10 l of hot water, and vacuum-dried at 130° C. This gave 2 kg of zinc diethylphosphinate (85% of theory) in the form of a white powder. The melting point is 209° C.

### Example 2

### Inventive

1.08 kg of methylethylphosphinic acid (10 mol) and 407 g (5 mol) of zinc oxide in 1.2 kg of acetic acid were heated at 100° C. over a period of 2 h in a 4 l stirred reactor, giving a clear solution. The acetic acid was then removed by distillation, and the viscous reaction mixture was dried and crystallized in vacuo at 130° C. The resultant product after grinding was 1.4 kg of zinc methylethylphosphinate (100% of theory) in the form of a white powder. The melting point is 205° C.

### Examples 3 to 5

### Comparative Examples

The calcium, barium, and magnesium salts of methylethylphosphinic acid were prepared from the corresponding hydroxides and finely ground, using the specification in example 2.

### Example 6

### Comparative Example

The aluminum salt of methylethylphosphinic acid was prepared from aluminum sulfate and finely ground, using the specification in example 1.

### Example 7

### Comparative Example

The aluminum salt of diethylphosphinic acid was prepared from aluminum sulfate and finely ground, using the specification in example 1.

TABLE 1
Melting points of phosphinic salts

| Example | Metal | Phosphinic acid | Melting point [° C.] |
|---|---|---|---|
| Example 1 | Zn | Diethylphosphinic acid | 209 |
| Example 2 | Zn | Methylethylphosphinic acid | 205 |
| Example 3 | Ca | Methylethylphosphinic acid | >350 (decomp.) |
| Example 4 | Ba | Methylethylphosphinic acid | >350 (decomp.) |
| Example 5 | Mg | Methylethylphosphinic acid | >350 (decomp.) |
| Example 6 | Al | Methylethylphosphinic acid | >350 (decomp.) |
| Example 7 | Al | Diethylphosphinic acid | >350 (decomp.) |

Examples 8 and 9 (using inventive phosphinic salts) and 10 to 15 (comparison)

Production of yams and knitted materials: The phosphinates of examples 1 to 7 were thoroughly mixed in a ratio of 1:1 with a ground PBT carrier material (®ULTRADUR B2550, BASF), and melted at 250° C. with the aid of a twin-screw extruder (Maris DSE 30), homogenized, extruded to give strands, cooled, and pelletized. The resultant masterbatch concentrates were mixed at 5% by weight with ®Trevira RT 20 polyethylene terephthalate pellets (95%), spun at 285° C. by means of a modified small-scale spinning plant (Fourne Maschinenbau GmbH), to give POY yarns, and wound up at 3000 m/min by way of a high-speed winder. Friction texturing with a drawing ratio of 1:1.6 was carried out in a further step on a ®RETECH TEX 2000, to give DTY yarns with a total linear density of 158 dtex and with 48 filaments. A Harry Lucas TK 83 circular knitting machine was used, with these DTY yarns, to manufacture the knitted materials needed for testing and assessment of the effects, the product being tubes of knitted polyester.

The criteria determined were the filter properties of the masterbatch concentrates, the spinning test results, and the oxygen indices, these being criteria relevant to industrial processing.

TABLE 2
Properties of knitted polyester tubes with 2.5%
phosphinate content

| | Phosphinate | Filter | Oxygen | Spinning |
|---|---|---|---|---|
| Example | from | properties¹ | index | test² |
| Example 8 | Example 1 | 0.01 | 0.45 | 0.2 |
| Example 9 | Example 2 | 0.01 | 0.44 | 0.3 |
| Example 10 | Example 3 | 1.39 | 0.33 | 2.1 |
| Example 11 | Example 4 | 4.53 | 0.31 | 5.3 |
| Example 12 | Example 5 | 3.21 | 0.32 | 4.8 |
| Example 13 | Example 6 | 2.83 | 0.35 | 4.2 |
| Example 14 | Example 7 | 2.90 | 0.35 | 4.2 |
| Example 15 | — | 0.00 | 0.32 | 0.0 |

¹The filter properties (bar/g of phosphinate) are a criterion for particle size, aggregates, and agglomerates, and were tested on the masterbatch concentrates by a standard test method (developed for the testing of dye concentrates and pigment concentrates, specifically for bulk coloration process in the fiber and filament sector).
Experience has shown the industrially relevant upper limit here to be 0.2 bar/g.
²For the spinning test, which is a criterion for the dispersion of the phosphinates within the polymer matrix, the throughput/polymer throughput, number of holes in the die, and draw-off speed are varied to extremes, thus giving a final linear density of about 1 dtex for a single filament (microfiber range).

The number of filament breakages per unit of time was measured. The industrially relevant tolerance limit here is less than or equal to (</=) 0.6/20 min.

The high oxygen indices of the knit tubes comprising zinc phosphinate indicate that the flame-retardant effect is superior when compared with other phosphinates.

The knitted materials thus produced have transparency comparable with example 15, and the appearance and feel of the final product are soft.

In contrast, the samples from examples 10 to 14 have a dull appearance, an unpleasant sandy feel, and high stiffness.

### Examples 16 to 23

### Production of Foils

An amount of 20% by weight of the phosphinates of examples 1 to 7 was incorporated into polybutylene terephthalate (®Celanex 2002, Ticbna) in a twin-screw extruder (Leistritz LSM 30/34) at a temperature of 260° C. The homogenized polymer strand was drawn off, cooled in a water bath, and then pelletized. After adequate drying, the molding compositions were further processed by means of a Collin W 150 M roll mill to give films of thickness 0.1 mm, the oxygen index was determined, and a visual assessment was also made.

TABLE 3
Properties of polyester foils with 20% phosphinate content

| | | | | Oxygen |
|---|---|---|---|---|
| Example | Phosphinate | Transparency | Surface | index |
| Example 16 | Example 1 | Yes | Smooth | 0.32 |
| Example 17 | Example 2 | Yes | Smooth | 0.31 |
| Example 18 | Example 3 | No | Slightly rough | 0.26 |
| Example 19 | Example 4 | No | Slightly rough | 0.23 |
| Example 20 | Example 5 | No | Slightly rough | 0.25 |
| Example 21 | Example 6 | No | Slightly rough | 0.27 |
| Example 22 | Example 7 | No | Slightly rough | 0.26 |
| Example 23 | — | Yes | Smooth | 0.20 |

The higher oxygen indices of the foils comprising zinc phosphinate indicate an increase in flame-retardant action when comparison is made with other phosphinates. The visual assessment of the foils indicates the marked advantages of these melting zinc phosphinates, examples being transparency and homogeneous dispersion.

1. A zinc phosphinate of the formula (I) and/or a polymer thereof, 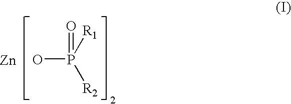
where R¹ and R² are identical or different, and are hydrogen, C₁-C₆-alkyl, linear or branched, and/or aryl, which has a melting point below 250° C.

2. The zinc phosphinate as claimed in claim 1, wherein R¹ and R² are identical or different, and are C₁-C₆-alkyl, linear or branched, and/or phenyl.

3. The zinc phosphinate as claimed in claim 1 or 2, wherein R¹ and R² are identical or different, and are methyl, ethyl, n-Propyl, iso-propyl, n-butyl, tert-butyl, n-pentyl and/or phenyl.

4. The zinc phosphinate as claimed in one or more of claims 1 to 3, which comprises zinc dimethylphosphinate, zinc methylethylphosphinate, and zinc diethylphosphinate.

5. A process for preparing the zinc phosphinates as claimed in one or more of claims 1 to 4, which comprises reacting phosphinic acids and/or salts thereof with the zinc compounds zinc chloride, zinc sulfate, zinc acetate, zinc nitrate, zinc oxide, zinc hydroxide, zinc carbonate, zinc hydroxide acetates, or zinc hydroxide carbonates, to give the zinc phosphinates.

6. The process for preparing the zinc phosphinates as claimed in claim 5, wherein the phosphinic acid used comprises dimethylphosphinic acid, methylethylphosphinic acid, or diethylphosphinic acid.

7. The process for preparing the zinc phosphinates as claimed in claim 5, wherein the phosphinic salts used comprise sodium dimethylphosphinate, sodium methylethylphosphinate, or sodium diethylphosphinate.

8. The process for preparing the zinc phosphinates as claimed in claim 5, wherein the zinc phosphinates are prepared in water or acetic acid.

9. The process for preparing the zinc phosphinates as claimed in claim 5, wherein phosphinic acid is reacted with zinc oxide in acetic acid and the material is then crystallized by vacuum-drying.

10. The process for preparing the zinc phosphinates as claimed in claim 5, wherein sodium phosphinate is reacted with zinc sulfate in water and the material is then isolated by filtration, washing and vacuum-drying.

11. A flame-retardant thermoplastic molding composition comprising a zinc phosphinate as claimed in one or more of claims 1 to 4.

12. The flame-retardant thermoplastic molding composition as claimed in claim 11, wherein the thermoplastic comprises polymers of the type represented by Hi (high-impact) polystyrene, polyphenylene ethers, polyamides, polyesters, polycarbonates, and blends or polyblends of the type represented by ABS (acrylonitrile-butadiene-styrene) or PC/ABS (polycarbonate/acrylonitrile-butadiene-styrene), or PPE/HIPS (polyphenylene ether/HI polystyrene) plastics.

13. The flame-retardant thermoplastic molding composition as claimed in claim 11 or 12, wherein the thermoplastic comprises polyamides, polyesters, and PPE/HIPS blends.

14. The flame-retardant thermoplastic molding composition as claimed in one or more of claims 11 to 13, which comprises an amount of from 1 to 50% by weight of the zinc phosphinate.

15. The flame-retardant thermoplastic molding composition as claimed in one or more of claims 11 to 14, which comprises an amount of from 1 to 25% by weight of the zinc phosphinate.

16. A polymer molding, a polymer film, a polymer filament, a polymer fiber, a woven polymer material, or a knitted polymer material, comprising a zinc phosphinate as claimed in one or more of claims 1 to 4.

17. A polymer molding, a polymer film, a polymer filament, a polymer fiber, a woven polymer material, or a knitted polymer material, as claimed in claim 16, wherein the polymer comprises Hi (high-impact) polystyrene, polyphenylene ethers, polyamides, polyesters, polycarbonates, and blends or polyblends of the type represented by ABS (acrylonitrile-butadiene-styrene) or PC/ABS (polycarbonate/acrylonitrile-butadiene-styrene), polyamide, polyester, and/or ABS.

18. A polymer molding, a polymer film, a polymer filament, a polymer fiber, a woven polymer material, or a knitted polymer material, as claimed in claim 16 or 17, wherein the polymer comprises polyamides or polyesters.

19. A polymer molding, a polymer film, a polymer filament, a polymer fiber, a woven polymer material, or a knitted polymer material, as claimed in one of more of claims 16 to 18, which comprises, based on the polymer content, an amount of from 1 to 50% by weight of the zinc phosphinate.
